(19) United States
(12) Patent Application Publication
(10) Pub. No.: US 2007/0162354 A1
(43) Pub. Date: Jul. 12, 2007

(54) Real-time electronic business transaction system and method for reporting STFC/FCT data to customer

(75) Inventors: Hung-Liang Chiu, Taipei (TW); Yi-Ming Liao, Taipei (TW); Ming-Feng Lee, Taipei (TW); Hua-Shan Hsu, Taichung (TW)

Correspondence Address: ROTHWELL, FIGG, ERNST & MANBECK, P.C., 1425 K STREET, N.W., SUITE 800, WASHINGTON, DC, 20005, US

(73) Assignee: Inventec Corporation, Taipei (TW)

(21) Appl. No.: 11/723,112

(22) Filed: Mar. 16, 2007

Related U.S. Application Data
(62) Division of application No. 09/944,122, filed on Sep. 4, 2001.

(51) Int. Cl. G06Q 30/00

(52) U.S. Cl. 705/26

(57) ABSTRACT

A real-time electronic business transaction system and method is proposed, which is capable of reporting STFC (Ship To First Commitment) and FCT (Factory Cycle Time) data in real time to a customer in response to an electronic purchase order from the customer. The proposed electronic business transaction system comprises an EDI (Electronic Data Exchange) platform, a SAP (Service Advertising Platform) platform, an SQL(Structured Query Language) server, and a WWW (World Wide Web) server. The EDI platform is linked to a customer-site workstation and is used to receive any electronic purchase order from the customer. The SAP platform is used to perform a predefined FCT computation procedure to compute for a set of FCT data based on the received electronic purchase order; while the SQL server is used to perform a predefined STFC computation procedure to compute for a set of STFC data based on the received electronic purchase order. The obtained FCT/STFC data are then posted on the WWW server so as to allow the customer to gain access to these FCT/STFC data via Internet.

### BACKGROUND OF THE INVENTION

1. Field of the Invention:

This invention relates to information technology, and more particularly, to a real-time electronic business transaction system and method for reporting FCT (Factory Cycle Time) and STFC (Ship To First Commitment) data to a customer in real time in response to an electronic purchase order from the customer.

2. Description of Related Art:

In the CEM (Contract Electronics Manufacturer) industry, when a manufacturer receives a purchase inquiry from a customer, the manufacture has to report related FCT and STFC data to the customer. FCT (Factory Cycle Time) indicates the number of days from the date of receiving the purchase order by the CEM to the date of shipping the ordered products to the customer; while STFC (Ship To First Commitment) indicates the original CEM-committed date of shipment to the customer.

The FCT/STFC data are computed by the CEM based on a number of factors, including quantity, type of product being ordered, factory throughput, and so on. Different manufacturers would use different FCT/STFC equations to compute for the customer-requested FCT/STFC. One example of the FCT/STFC computation equations is shown below:
FCT=(EDT856 Time)−(EDT850 Time)
Average=Sum [(ED1856−ED1850)]({tilde under (Q)}ty of EDI 856)]/Sum({tilde under (Q)}ty of EDI856)
Max=Max [(EDI856−EDI850)]
Min=Min [(EDI856−EDI850)]
   STFC=(EDT856 Time)−(EDT855 Time)
Average=Sum [(EDI856−EDI855)]*({tilde under (Q)}ty of EDI 856)]/Sum({tilde under (Q)}ty of EDI856)
Max=Max [(EDI856−EDI855)]
Min=Min [(EDI856−EDI855)]

Since the FCT/STFC computation procedure is specific to a particular CEM and its related background knowledge is well-known in the CEM industry, description thereof will not be further detailed.

FIG. 1 is a schematic diagram showing the system configuration of a conventional electronic business transaction system (the dashed block indicated by the reference numeral 100) for reporting FCT/STFC data to customer, while FIG. 2 is a flow diagram showing the procedural steps performed by the conventional electronic business transaction system 100 shown in FIG. 1.

As shown in FIG. 1, this conventional electronic business transaction system 100 includes: (a) an EDI (Electronic Data Interchange) platform 110; (b) a SAP (Service Advertising Protocol) platform 120; (c) a CEM specialist 130 (which is a human being rather than a machine); (d) and a customer service workstation 140.

The EDI platform 110 is linked to a customer-site workstation 10 through a network system, such as Internet 20, and is used to receive electronic purchase order from the customer-site workstation 10 in EDI-compliant format, such as EDI 850. The EDI (Electronic Data Interchange) is a well known standard in the information industry, so description thereof will not be further detailed.

The SAP platform 120 is linked to the EDI platform 110 and is capable of performing a predefined FCT computation procedure to compute for a set of FCT data based on the received electronic purchase order. The SAP (Service Advertising Protocol) is also a well known standard in the information industry, so description thereof will not be further detailed.

The CEM specialist 130 is a member of the customer service staff, who is specialized in STFC computation and is responsible for manually computing for a set of STFC data based on the received electronic purchase order by using, for example, a calculator.

The customer service workstation 140 is a computer unit, such as a desktop personal computer or an equivalent, which is linked to the Internet 20 and installed with E-mail functionality. A customer serviceperson is assigned to sit at this customer service workstation 140 and is responsible for sending customer-requested business information in E-mail via the Internet 20 to the customer.

Referring to FIG. 2 together with FIG. 1, when a customer wants to issue a purchase order to the CEM, the first step S10 is to use the customer-site workstation 10 to transfer the purchase order in electronic form, such as EDI 850, via the Internet 20 to the electronic business transaction system 100.

In the next step S11, the EDI platform 110 receives the electronic purchase order from the customer-site workstation 10 and then forwards it to the SAP platform 120 and the CEM specialist 130 who is specialized in STFC computation.

In the next step S12, the SAP platform 120 performs a predefined FCT computation procedure to compute for a set of FCT data based on the received electronic purchase order.

In the next step S13, the CEM specialist 130 manually computes for a set of STFC data based on the received electronic purchase order by using, for example, a calculator.

In the next step S14, the obtained FCT data and STFC data are forwarded to the customer service workstation 140 where a customer serviceperson is responsible for sending the FCT/STFC data in E-mail via the Internet 20 to the customer.

One drawback to the forgoing electronic business transaction system and method, however, is that it would take the customer quite a long time to wait for the returned FCT/STFC data in E-mail. This is because that the step S13 and the step S14 involve human power to perform the required STFC computation and E-mail operation, which would make the overall procedure quite time-consuming and thus slow in reporting the FCT/STFC data to the customer.

There exist therefore a need in the CEM industry for a new electronic business transaction system and method that allows the customer to receive the FCT/STFC data substantially in real time, so as to make the business transaction more efficient.

### SUMMARY OF THE INVENTION

It is therefore an objective of this invention to provide an electronic business transaction system and method that can report FCT/STFC data to the customer substantially in real time.

It is another objective of this invention to provide an electronic business transaction system and method that can report FCT/STFC data to the customer without having to involve human power to perform STFC computation and E-mail operation. The electronic business transaction system according to the invention comprises an EDI (Electronic Data Exchange) platform, a SAP (Service Advertising Platform) platform, an SQL(Structured Query Language) server, and a WWW (World Wide Web) server. The EDI platform is linked to a customer-site workstation and is used to receive electronic purchase order from the customer. The SAP platform is used to perform a predefined FCT computation procedure to compute for a set of FCT data based on the received electronic purchase order; while the SQL server is used to perform a predefined STFC computation procedure to compute for a set of STFC data based on the received electronic purchase order. The obtained FCT/STFC data are then posted on the WWW server so as to allow the customer to gain access to these FCT/STFC data via Internet.

Upon the reception of an electronic purchase order by the EDI platform, the first step is to use the SAP platform to perform a predefined FCT computation procedure on an SAP platform to compute for a set of FCT data based on the received electronic purchase order, and then use the SQL server to perform a predefined STFC computation procedure on an SQL server to compute for a set of STFC data based on the received electronic purchase order. The obtained FCT/STFC data are then posted on the WWW server, so as to allow the customer to gain access to the FCT/STFC data posted on the WWW server by linking to the WWW server via Internet and view these FCT/STFC data by means of a Web browser, such as such as Microsoft Internet Explorer or Netscape Navigator.

Compared to the prior art, the invention allows the reporting of FCT/STFC data to the customer to be carried out in a fully-automatic and real-time manner without having to involve any human power. The invention is therefore more efficient and advantageous to use than the prior art.

### BRIEF DESCRIPTION OF DRAWINGS

The invention can be more fully understood by reading the following detailed description of the preferred embodiments, with reference made to the accompanying drawings, wherein:

FIG. 1 (PRIOR ART) is a schematic diagram showing the system configuration of a conventional electronic business transaction system for reporting FCT/STFC data to customer;

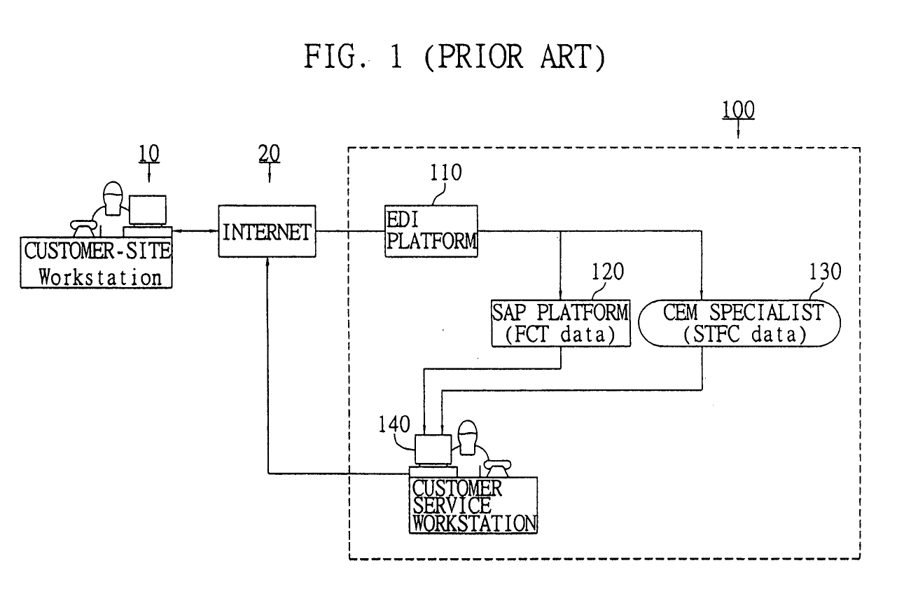

FIG. 2 (PRIOR ART) is a flow diagram showing the procedural steps performed by the conventional electronic business transaction system of FIG. 1;

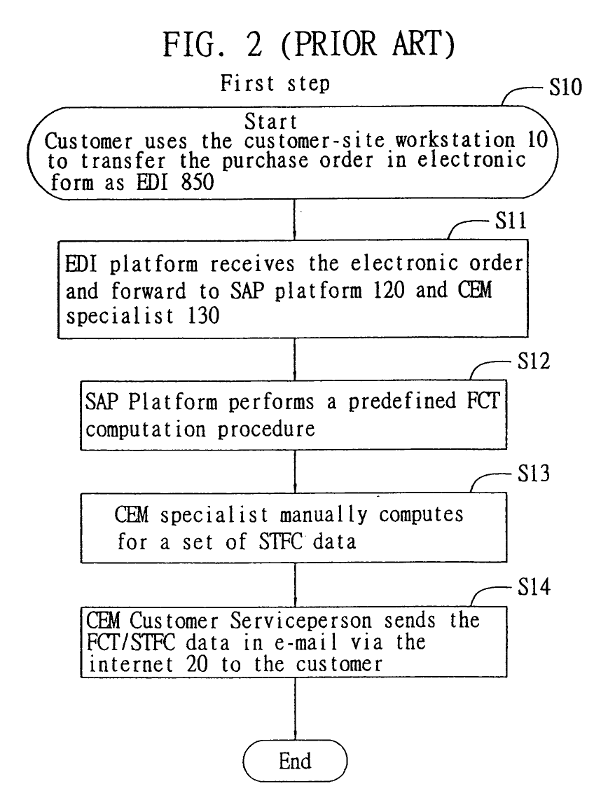

FIG. 3 is a schematic diagram showing the system configuration of the electronic business transaction system of the invention for reporting FCT/STFC data to customer; and

FIG. 4 is a flow diagram showing the procedural steps performed by the electronic business transaction system of the invention.

### DETAILED DESCRIPTION OF PREFERRED EMBODIMENTS

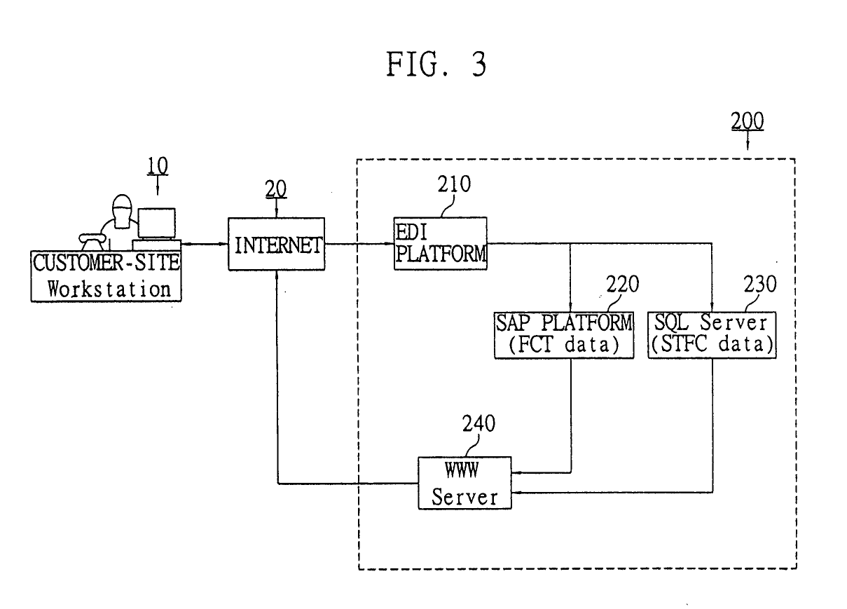

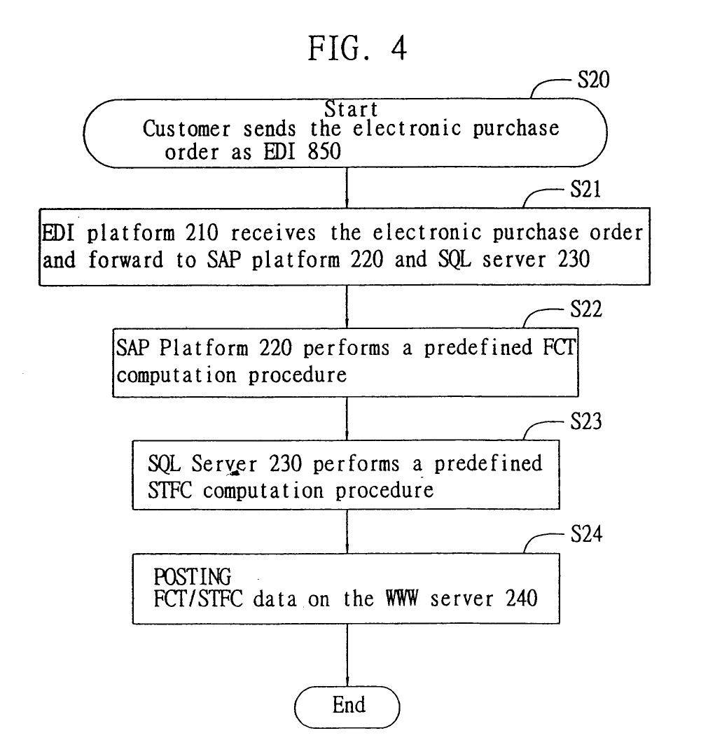

The electronic business transaction system and method according to the invention for reporting FCT/STFC data to customer is disclosed in full details in the following with reference to FIG. 3 and FIG. 4; wherein FIG. 3 shows the system configuration of the electronic business transaction system according to the invention; and FIG. 4 is a flow diagram showing the procedural steps performed by the electronic business transaction system of the invention.

Referring first to FIG. 3, the electronic business transaction system according to the invention (the dashed block indicated by the reference numeral 100) comprises: (a) an EDI (Electronic Data Interchange) platform 210; (b) a SAP (Service Advertising Protocol) platform 220; (c) an SQL (Structured Query Language) server 230; and (d) a database server such as a WWW (World Wide Web) server 240.

The EDI platform 210 is linked to a customer-site workstation 10 through a network system, such as the Internet 20, and is used to receive electronic purchase order from the customer-site workstation 10 in EDI-compliant form, such as EDI 850.

The SAP platform 220 is linked to the EDI platform 210 and is capable of performing a predefined FCT computation procedure to compute for a set of FCT data based on the received electronic purchase order.

The SQL server 230 is also linked to the EDI platform 210 and is capable of performing a predefined STFC computation procedure to compute for a set of STFC data based on the received electronic purchase order. The SQL (Structured Query Language) is a well known database standard in the information industry, so description thereof will not be further detailed.

The WWW server 240 is linked to the Internet 20 and is capable of serving the above-mentioned FCT/STFC data to any customer site that is linked to the Internet 20. When linked to the WWW server 240 via the Internet 20, the customer can utilize a Web browser, such as Microsoft Internet Explorer or Netscape Navigator, to view the FCT/STFC data posted on the WWW server 240.

Referring to FIG. 4 together with FIG. 3, when a customer wants to issue a purchase order to the electronic business transaction system 200, the first step S20 is to use the customer-site workstation 10 to transfer the purchase order in electronic form, such as EDI 850, via the Internet 20 to the EDI platform 210.

In the next step S21, the EDI platform 210 receives the electronic purchase order from the customer-site workstation 10 and then forwards the received electronic purchase order to the SAP platform 220 and the SQL server 230.

In the next step S22, the SAP platform 220 performs a predefined FCT computation procedure to compute for a set of FCT data based on the received electronic purchase order.

In the next step S23, the SQL server 230 performs a predefined STFC computation procedure to compute for a set of STFC data based on the received electronic purchase order. It is a characteristic feature of the invention that the STFC computation is here performed fully automatically by the SQL server 230 without having to involve human power.

In the next step S240, the FCT data obtained by the SAP platform 220 and the STFC data obtained by the SQL server 230 are posted on the WWW server 240, so as to allow the customer who issued the electronic purchase order to gain access to the FCT/STFC data posted on the WWW server 240 via the Internet 20. When linked to the WWW server 240 via the Internet 20, the customer can utilize a Web browser running on the customer-site workstation 10, such as Microsoft Internet Explorer or Netscape, to view the posted FCT/STFC data on the WWW server 240.

Compared to the prior art, the invention allows the reporting of FCT/STFC data to the customer to be carried out in a fully-automatic and real-time manner without having to involve any human power. Moreover, since the invention can be implemented without having to involve any human power, it would help the business transaction to be more cost-effective. The invention is therefore more efficient and advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1-5. (canceled)

6. A method for reporting FCT (Factory Cycle Time)/STFC (Ship To First Commitment) data to customer in response to an electronic purchase order from the customer, comprising the steps of:
(1) receiving the electronic purchase order via an EDI (Electronic Data Interchange) platform;
(2) performing a predefined FCT computation procedure on an SAP (Service Advertising Protocol) platform to compute for a set of FCT data based on the received electronic purchase order;
(3) performing a predefined STFC computation procedure on an SQL (Structured Query Language) server to compute for a set of STFC data based on the received electronic purchase order; and
(4) posting the FCT/STFC data on a WWW (World Wide Web) server connected to Internet, so as to allow the customer to gain access to the FCT/STFC data posted on the WWW server by linking to the WWW server via Internet.

7. (canceled)
